(19) United States
(12) Patent Application Publication
(10) Pub. No.: US 2009/0022442 A1
(43) Pub. Date: Jan. 22, 2009

(54) Pitch Bearing For A Wind Turbine, A Wind Turbine And A Method For Servicing A Bearing

(76) Inventors: Anton BECH, Ringkobing (DK); Gerry MADDEN, Milton Keynes (GB)

Correspondence Address: ST. ONGE STEWARD JOHNSTON & REENS, LLC, 986 BEDFORD STREET, STAMFORD, CT, 06905-5619, US

(21) Appl. No.: 12/241,787

(22) Filed: Sep. 30, 2008

Related U.S. Application Data
(63) Continuation of application No. PCT/DK2007/000162, filed on Mar. 30, 2007.

(30) Foreign Application Priority Data
Apr. 2, 2006 (DK) PA 2006 00469

(51) Int. Cl. F16C 19/49

(52) U.S. Cl. 384/454

(57) ABSTRACT

The invention relates to a pitch bearing for a wind turbine comprising a first and second axial row of bearing rolling elements, said rows being positioned in a distance of each other, and one or more radial rows of bearing elements, where said one or more rows of bearing elements are positioned outside an area defined in between said first and second axial row. The invention also relates to a wind turbine and method for servicing a bearing hereof.

### CROSS-REFERENCE TO RELATED APPLICATIONS

The present application is a continuation of pending International patent application PCT/DK2007/000162, filed Mar. 30, 2007, which designates the United States and claims priority from Danish patent application no. PA 2006 00469, filed Apr. 2, 2006, the content of which is incorporated herein by reference.

### FIELD OF THE INVENTION

The present invention relates to a pitch bearing for a wind turbine, a wind turbine and a method for servicing a bearing.

### BACKGROUND OF THE INVENTION

A typical bearing in a wind turbine has been the 4-point contact ball bearing e.g. in a blade pitch mechanism. This bearing design has shown its suitability to take the complexes load patterns the blade act on the bearing with.

As the blade rotates in the gravity field, the wind related loads are super positioned by gravity related loads. These gravity loads are cyclic and change directions during the rotation of the rotor. This causes the loads in some areas of the bearing to change directions to which the bearing will flex from one side of the play to the other. Such movements have been in favor for ball bearing as the ball can roll to absorb such movements.

However, by the increasing size of the modern wind turbine, the ball bearing lacks capacity to handle the increase in load.

Rollers have such properties; hence roller bearings are of interest. As the bearing sees large changes of loads and directions, there will be some flexure in the axial direction of the bearing. If the bearing has some axial play as well, this is added to the flexure from the loads. This flexure will cause sliding in the radial rollers and consequently deteriorate the bearing.

It is therefore an object of the present invention to provide a solution which is more efficiently adapted to the increasing loads of bearings for a modern wind turbine.

### SUMMARY OF THE INVENTION

The invention provides a pitch bearing for a wind turbine comprising a first and second axial row of bearing rolling elements, said rows being positioned in a distance of each other, and one or more radial rows of bearing elements, where said one or more rows of bearing elements are positioned outside an area defined in between said first and second axial row.

Hereby are the abovementioned disadvantages of the prior art avoided in an advantageous manner.

In an aspect of the invention, said one or more radial rows of bearing elements are positioned on the upper side of the bearing above the first and second axial row e.g. close to the blade side of the pitch bearing or said one or more radial rows of bearing elements are positioned on the lower side of the bearing below the first and second axial row e.g. close to the hub side of the pitch bearing. If the radial row is relocated from in between the two axial races to the upper of the bearing, this part of the bearing becomes more access able from the outside on the blade side or from the inside on the hub side and thus easier to perform service on without having to remove the blade.

In an aspect of the invention, said one or more radial rows of bearing elements comprise sliding surfaces sliding on the roller end surfaces of at least one of said first and second axial row. Such a design would allow the bearing to be made more compact and with lower cost and of lower weight.

The invention further relates to a wind turbine comprising at least one blade, and at least one pitch mechanisms with one or more bearings according to any of claim 1 to 19.

The invention also relates to a method for servicing a bearing according to any of claim 1 to 19 of a pitch bearing in a wind turbine, said method comprising the steps of:
removing any retaining means from the blade or the hub side of the pitch bearing
lifting out the bearing elements of a radial row of bearing elements including the rolling elements and/or the raceways,
inspecting, renovating or replacing the bearing elements, and
positioning the bearing elements and retaining means in their work position.

If the radial row is relocated from in between the two axial races to the upper of the bearing, this part of the bearing becomes more access able from the outside on the blade side or from the inside on the hub side and thus easier to perform service on without having to remove the blade.

### BRIEF DESCRIPTION OF THE DRAWINGS

The invention will be described in the following with reference to the figures in which

FIG. 1 illustrates a large modern wind turbine,

FIG. 2 illustrates a cross sectional view of a well known bearing type in a wind turbine application such as a pitch mechanism,

FIGS. 3a and 3b illustrate a cross sectional view of a first embodiment of a bearing according to the invention,

FIG. 4 illustrates an upper part of a second embodiment of a bearing according to the invention,

FIG. 5 illustrates an upper part of a third embodiment of a bearing according to the invention,

FIG. 6 illustrates an upper part of a fourth embodiment of a bearing according to the invention,

FIG. 7 illustrates an upper part of a fifth embodiment of a bearing according to the invention,

FIG. 8 illustrates an embodiment of a bearing in a first and second section according to the invention,

FIG. 9 illustrates an embodiment of a bearing with rows of fixed bearing elements, and

FIG. 10 illustrates an embodiment of a bearing with rows of flexible bearing elements.

### DETAILED DESCRIPTION OF THE INVENTION

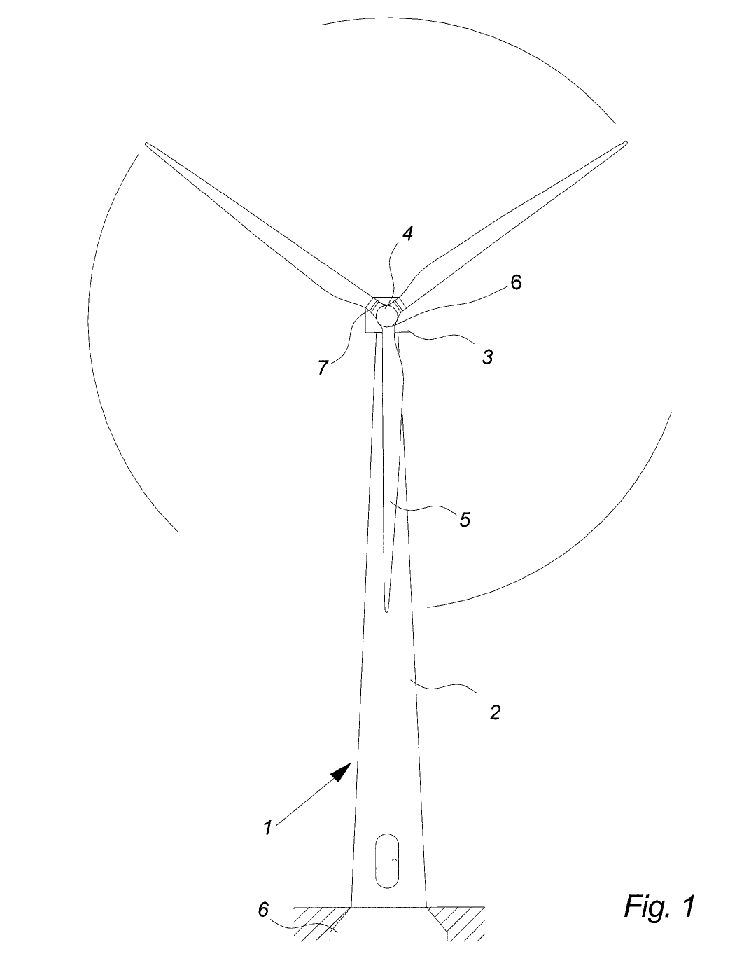

FIG. 1 illustrates a modern wind turbine 1. The wind turbine 1 comprises a tower 2 positioned on a foundation 6. A wind turbine nacelle 3 with a yaw mechanism is placed on top of the tower 2.

The wind turbine rotor comprises at least one rotor blade e.g. three rotor blades 5 as illustrated on the figure. The rotor blades 5 are pitchable in relation to the hub 4 by using pitch mechanisms.

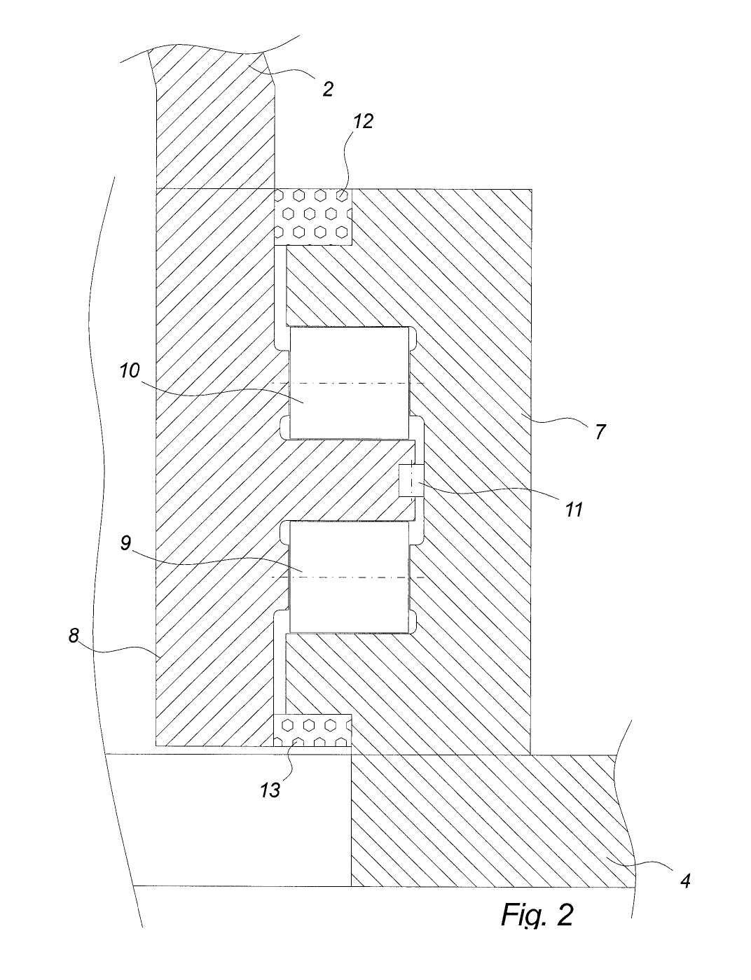

FIG. 2 illustrates a well known bearing type (3RR configuration) in a wind turbine application such as a pitch mechanism.

The bearing comprises 3 rows of rolling elements. The first and second axial row 9, 10 of rolling bearing elements is positioned between two different sets of horizontal raceways on an inner 8 and outer ring 7. The two rows may especially handle and transfer axial loads. The third row 11 is a radial row of rolling bearing elements with a set of vertical raceways between the inner 8 and outer ring 7 and may especially handle and transfer radial loads of the bearing.

The first and second sealing means 12, 13 are a steel or rubber component that has several important uses and are crucial to the functioning of the bearing. It separates the bearing rolling elements from the outside world, stops dirt and moisture from entering and prevents lubricants from leaking to the outside. The sealing means are integrated in the bearing and mounted between the outer and inner ring 7, 8 at the upper and lower entrances of the bearing.

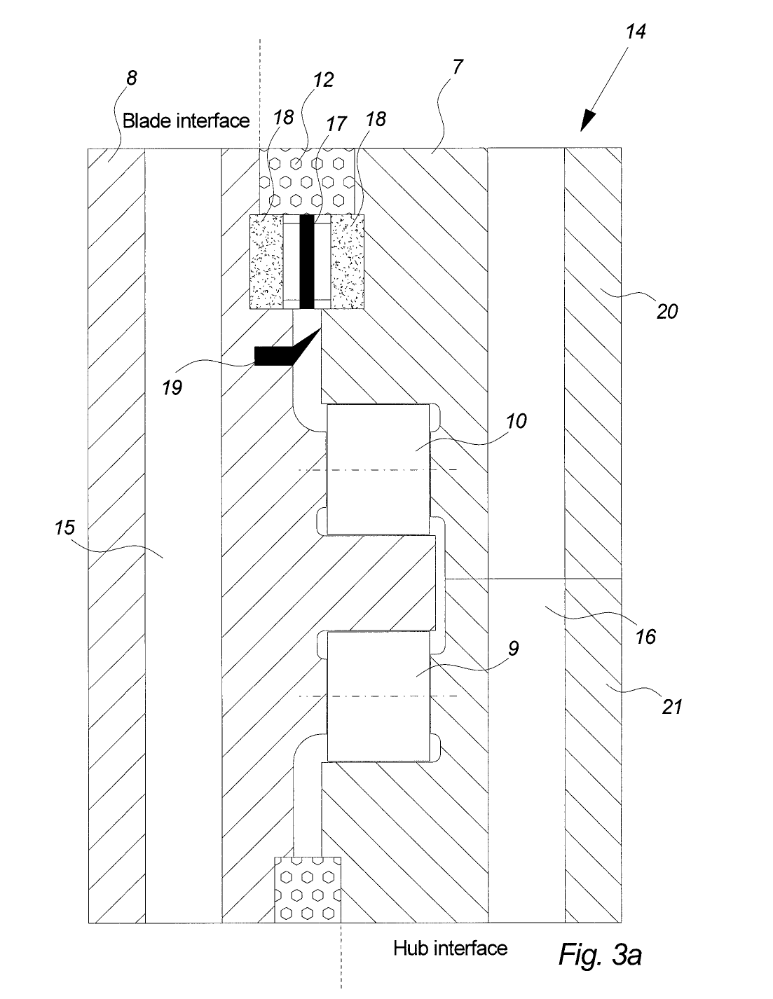

FIG. 3a illustrates a cross sectional view of a first embodiment of a bearing according to the invention.

The bearing 14 comprises an outer and inner bearing ring 7, 8 comprising sets of raceways.

Two horizontal sets of raceways hold two axial rows 9, 10 of rolling elements such as rollers. The two axial rows 9, 10 are separated by a horizontal extension part of the inner bearing ring 8 holding some of the horizontal raceways. Similarly the outer ring comprises an upper and lower extension part holding the further horizontal raceways for the two axial rows.

The radial row 17, 18 of bearing elements is positioned above the two axial rows 9, 10 at the blade side of the bearing 14. The radial row comprises some kind of rolling element 17 and corresponding raceways 18 in opposite side of the inner and outer ring 7, 8. The raceways are illustrated as extending into the inner and outer ring and as such keeping the raceways vertically in place during normal use. The bearing rolling elements further keep the raceways horizontally in place during normal use.

The different rows of rolling elements are preferably positioned in rolling cages or any similar assemblies to retain the rolling elements in place. Further, the rolling elements may be part of a full compliance bearing i.e. rolling elements positioned side by side leaving no space in between.

The radial row 17, 18 of bearing elements is protected from the outside by sealing means 12 which closes the opening between the inner and outer ring 7, 8 at the surface of the bearing blade side.

The radial row 17, 18 of bearing elements will be accessible from the outside at the blade side when the sealing means 12 is removed.

The raceways can be a solid part of the rings or loose inlays. Preferably in relation to loose inlays, each of the raceways is a broken ring or a number of ring segments e.g. 2*180 degrees, 4*90 degrees etc. Hereby it is possible to lift up the raceway or segments of raceway after the bearing rolling elements and the sealing means have been removed.

This change of position for the radial row gives following options:
The bearing can be inspected, services or replaced without the main bearing (the 2 axial races) are disconnected from the hub or blade.
The wear fragments or debris from failure can be insulated from the primary bearing (by the seal 19 shown beneath the radial row of the bearing)
The hub side of the bearing is very inflexible where the bearing flexibility increases with the distance from the hub. Thus the radial bearing can be preloaded more safely, as the height of the outer ring give some possibility for flexure.
A spring can be built in behind one or both of the radial bearing rings to assure better control of pretension or to protect the bearing from excessive internal forces from geometrical deviations like out of roundness tolerances.
The rolling elements can also be balls or cambered rollers as the space for the radial bearing is less constrained by the main bearing when on top of the bearing than inside.
Plain bush bearing is a possibility.

These possibilities and embodiments according to the invention will be further explained below in connection with the accompanying figures.

It shall be emphasized that the inner T shape and outer C shape may just as well be reversed into an inner C shape and outer T shape.

Blade interface is the side of the bearing facing the wind turbine blade.

Hub interface is the side of the bearing facing the wind turbine hub.

FIG. 3b illustrates the cross sectional view of the first embodiment in FIG. 3a where the radial row is moved to a position below the first and second axial row 9, 10.

The radial row 17, 18 of bearing elements is protected from the outside by sealing means 13 which closes the opening between the inner and outer ring 7, 8 at the surface of the hub blade side.

The radial row 17, 18 of bearing elements will be accessible from inside the hub when the sealing means 13 is removed.

Further, the radial row of bearing elements 17, 18 is pre stressed or pre loaded by at least one of the raceways 18 being put in by flexible bearing means 28 e.g. spring means such as a helical spring. The flexible bearing means 28 creates flexibility at the radial row in relation to the very inflexible position at the hub side.

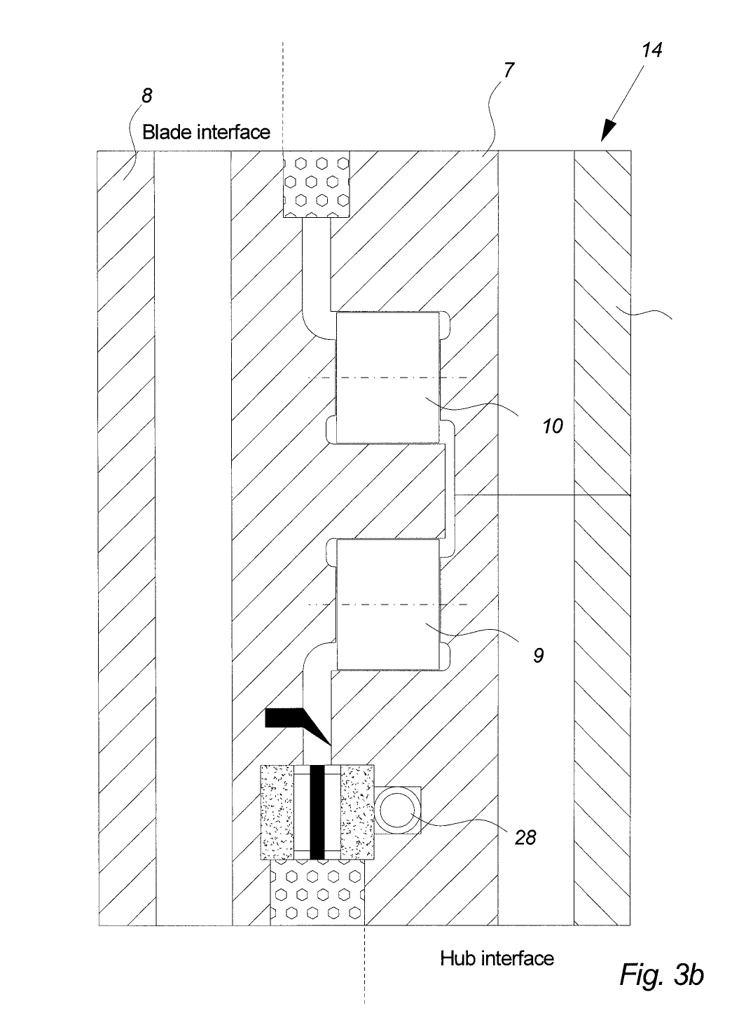

FIG. 4 illustrates an upper part of a second embodiment of a bearing according to the invention wherein the radial row is established with chambered rollers.

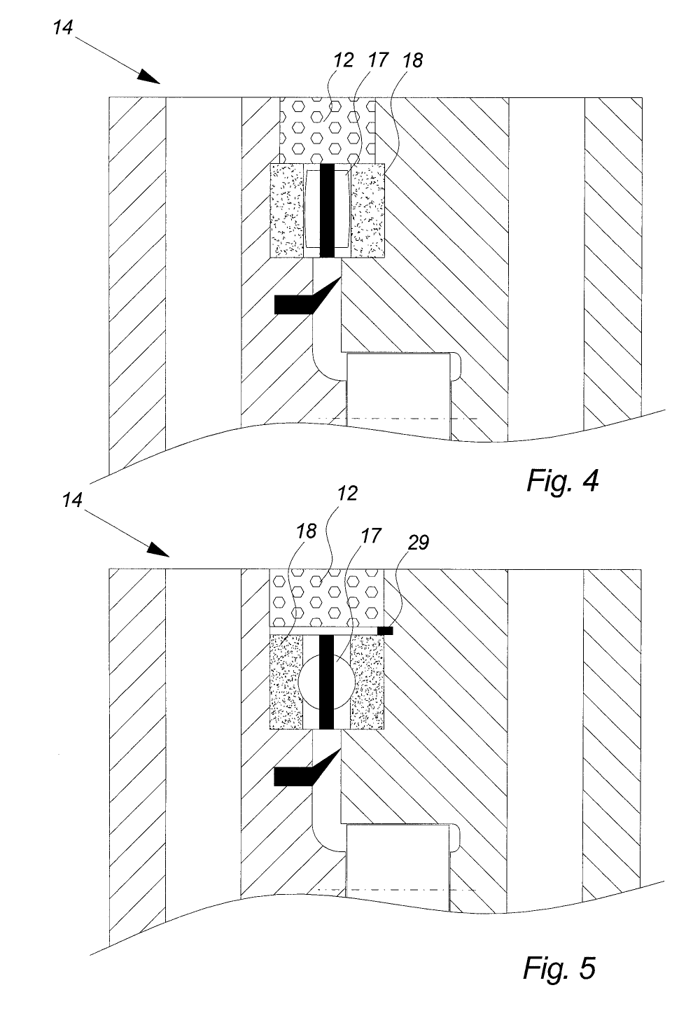

FIG. 5 illustrates an upper part of a third embodiment of a bearing according to the invention.

The radial row is established with a ball bearing with raceways shaped to guide the balls. A low conformity between the balls and the raceways may be preferred in order to allow axial movement within the radial ball bearing. The lower conformity may be obtained by oval shaped raceways or larger diameter on the relevant parts of the raceways in relation to the ball diameter.

Spring holding means 29 is positioned in a notch of the outer ring in order to retain the ball bearing in place during normal use. The notch is positioned in between the sealing means 12 and the ball bearing.

The spring holding means 29 may also be positioned in a notch of the inner ring or in notches of both the outer and inner ring.

The sealing means 12 are illustrated as having the width as the ball bearing including the raceways. Hereby it is possible to lift out the ball bearing as a whole after the spring holding means 29 have been removed.

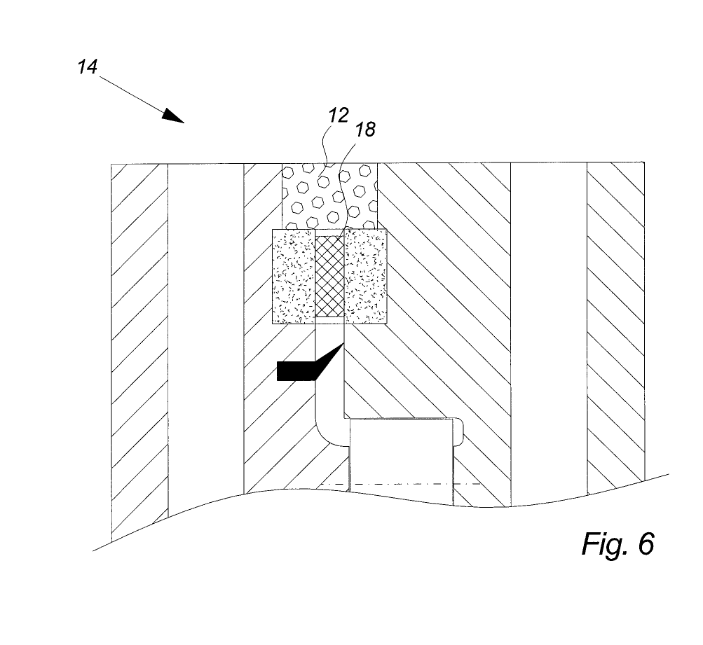

FIG. 6 illustrates an upper part of a fourth embodiment of a bearing according to the invention.

The radial row is established with a plain bush bearing (glide bearing). The bush may be made in plastic or metal such as PTFE, POM, PA and steel. Further, the bush may be made in a combination of metal and plastic materials.

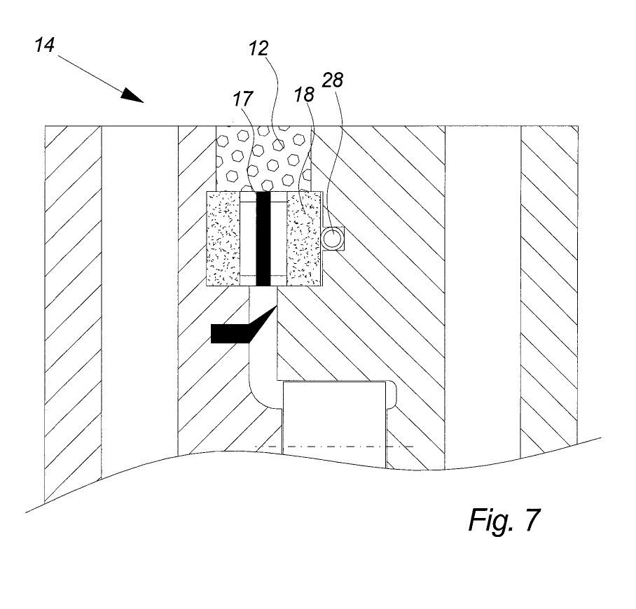

FIG. 7 illustrates an upper part of a fifth embodiment of a bearing according to the invention.

The radial row of bearing elements 17, 18 may be pre stressed or pre loaded by at least one of the raceways 18 being forced by flexible bearing means 28 e.g. one or more spring means such as a helical spring.

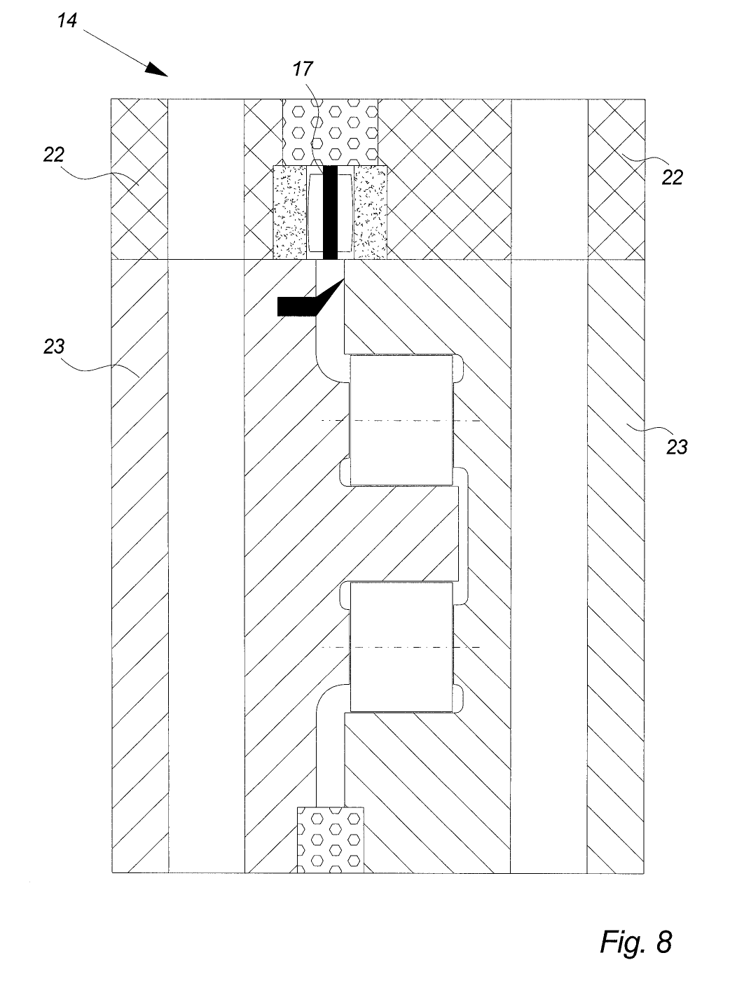

FIG. 8 illustrates an embodiment of a bearing according to the invention. The bearing is made with a first and second separate part forced against each other by the blade and hub bolts.

The radial row of the bearing is illustrated in a separate part 22 of the bearing containing cylindrical roller, cambered roller or ball as rolling element or a plane bush bearing between an inner and outer ring. The lower part 23 of the bearing comprises the first and second axial row between another inner and outer ring.

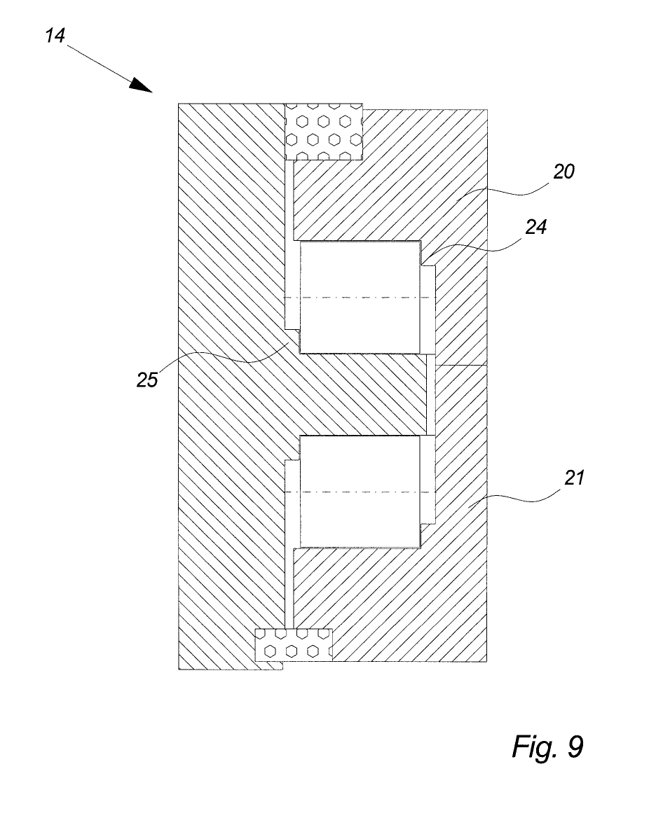

FIG. 9 illustrates an embodiment of a bearing according to the invention with rows of fixed bearing elements in the form of ribs extending from the inner and outer ring.

Especially in blade applications it may be possible to use the ribs that guide the axial rows of rollers to provide the radial location and support function within the bearing.

To assist the good functioning of the rib-locating design, the design may include the following features:
i) tighter length tolerances on rollers
ii) a modified end form on rollers
iii) a small lean-back angle on the ribs

Such a design would allow the bearing to be made more compact and with lower cost and of lower weight.

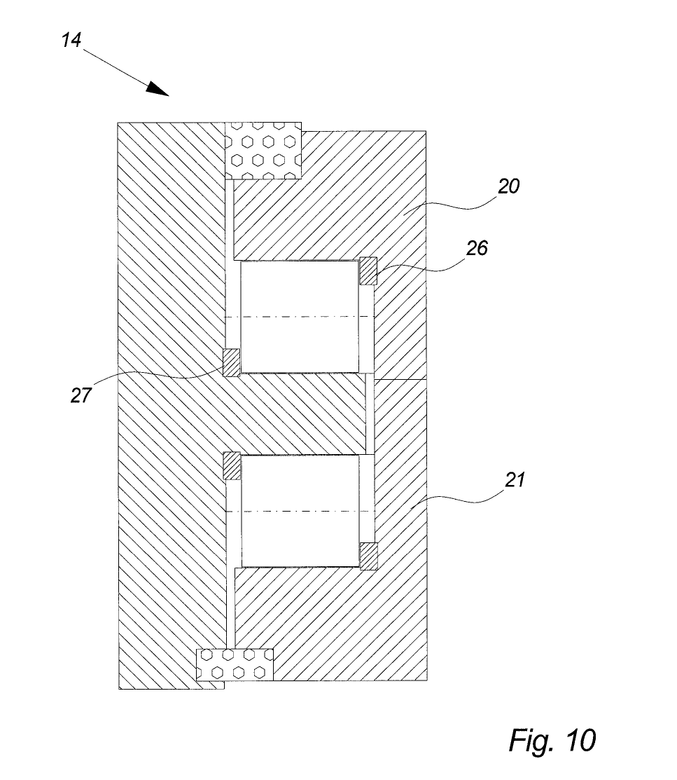

FIG. 10 illustrates an embodiment of a bearing with rows of flexible bearing elements.

The figure illustrates the one or more radial rows as separate sliding bearing means 26, 27 positioned on the inner and outer ring. The radial rows 24-27 may preferably be made in metal such as steel, brass or plastic such as POM or PA.

It shall be emphasized that any combination of the aspects in the above mentioned embodiments may be used in designing the bearing of the present invention.

Even further, the bearing may be designed in a multitude of varieties within the scope of the invention as specified in the claims.

### REFERENCE LIST

In the drawings the following reference numbers refer to:
1. Wind turbine
2. Wind turbine tower
3. Wind turbine nacelle
4. Wind turbine rotor hub
5. Wind turbine rotor blade
6. Wind turbine foundation
7. Outer bearing ring
8. Inner bearing ring
9. First axial row of rolling bearing elements for axial loads
10. Second axial row of rolling bearing elements for axial loads
11. Row of rolling bearing elements for radial loads
12. First sealing means
13. Second sealing means
14. Bearing for a wind turbine application
15. First through-going hole for a blade bolt
16. Second through-going hole for a hub bolt
17. Radial row of rolling bearing elements for radial loads
18. Raceways for the radial row of rolling bearing elements
19. Shielding means between radial and axial rows of rolling bearing elements
20. First outer ring section of the bearing
21. Second outer ring section of the bearing
22. Upper bearing section
23. Lower bearing section
24. First row of fixed bearing elements
25. Second row of fixed bearing elements
26. First row of separate sliding bearing elements
27. Second row of separate sliding bearing elements
28. Flexible bearing means such as a spring
29. Spring holding ring

1. A pitch bearing for a wind turbine comprising
a first and second axial row of bearing rolling elements, said rows being positioned in a distance of each other, and
one or more radial rows of bearing elements,
where said one or more rows of bearing elements are positioned outside an area defined in between said first and second axial row.

2. Pitch bearing according to claim 1 wherein said bearing comprises two races in an axial bearing configuration and one or more races in a radial configuration as a part of a blade pitch mechanism.

3. Pitch bearing according to claim 1 wherein said one or more radial rows of bearing elements are positioned on the upper side of the bearing above the first and second axial row e.g. close to the blade side of the pitch bearing or said one or more radial rows of bearing elements are positioned on the lower side of the bearing below the first and second axial row e.g. close to the hub side of the pitch bearing.

4. Pitch bearing according to claim 1 wherein said one or more radial rows of bearing elements include a radial bearing with cylindrical rollers, cambered rollers, balls, plane bush bearing or any similar type of rolling elements between two raceways.

5. Pitch bearing according to claim 1 wherein sealing means are positioned above said one or more radial rows of bearing elements.

6. Pitch bearing according to claim 5 wherein said sealing means and any accompanying means retain said one or more radial rows of bearing elements in position.

7. Pitch bearing according to claim 5 wherein spring holding means, positioned between said sealing means and said one or more radial rows of bearing elements in a notch of said outer and/or inner ring, retains said one or more radial rows in position.

8. Pitch bearing according to claim 4 wherein each of said raceways is a broken ring or a number of ring segments.

9. Pitch bearing according to claim 8 wherein there are two raceways of 180 degrees.

10. Pitch bearing according to claim 8 wherein there are four raceways of 90 degrees.

11. Pitch bearing according to claim 4 wherein said one or more radial rows of bearing elements is pre stressed or pre loaded by at least one of said raceways being put in by flexible bearing means.

12. Pitch bearing according to claim 11 wherein said flexible bearing means include at least one spring means.

13. Pitch bearing according to claim 1 wherein said one or more rows of bearing elements is positioned in an upper section and said axial rows in a lower section of the bearing.

14. Pitch bearing according to claim 1 wherein said first and second axial row of bearing rolling elements comprise a number of rollers and preferably in rolling cages or any similar assemblies to retain the rollers in place.

15. Pitch bearing according to claim 14 wherein said one or more radial rows of bearing elements comprise sliding surfaces sliding on the roller end surfaces of at least one of said first and second axial row.

16. Pitch bearing according to claim 14 wherein said one or more radial rows comprise sliding surfaces sliding on each of said axial rows.

17. Pitch bearing according to claim 14 wherein said one or more radial rows slide on one or more sections of the end surfaces.

18. Pitch bearing according to claim 17 wherein said one or more radial rows slide on the upper and lower section of the end surfaces, respectively e.g. on the upper section from the outer ring and on the lower section from the inner ring or vice versa.

19. Pitch bearing according to claim 14 wherein said one or more radial rows are fixed projections of the inner and outer ring.

20. Pitch bearing according to claim 19 wherein said fixed projections are ribs.

21. Pitch bearing according to claim 14 wherein said one or more radial rows are separate sliding bearing means positioned on the inner and outer ring.

22. Pitch bearing according to claim 14 wherein said one or more radial rows are made in metal such as steel, brass or plastic such as POM or PA.

23. Wind turbine comprising a pitch bearing according to claim 1 inserted in a pitch mechanism of the wind turbine.

24. Method for servicing a bearing according to claim 1, said method comprising the steps of:
removing any retaining means from the blade or the hub side of the pitch bearing,
lifting out the bearing elements of a radial row of bearing elements including the rolling elements and/or the raceways,
inspecting, renovating or replacing the bearing elements, and
positioning the bearing elements and retaining means in their work position.
